(19) United States
(12) Patent Application Publication
(10) Pub. No.: US 2026/0097935 A1
(43) Pub. Date: Apr. 9, 2026

(54) STRUT STRUCTURE FOR A CRANE COMPRISING A TOGGLE LEG AT THE FOOT OF THE STRUT ARM

(71) Applicant: MANITOWOC CRANE GROUP FRANCE, DARDILLY (FR)

(72) Inventors: Mayeul JUSNEL, SAINT CHAMOND (FR); Volker RODENBECK, HOHENBERG KRUSEMARK (DE)

(21) Appl. No.: 19/348,193

(22) Filed: Oct. 2, 2025

(30) Foreign Application Priority Data
Oct. 4, 2024 (FR) FR2410717

(51) Int. Cl. B66C 23/82

(52) U.S. Cl. CPC B66C 23/823

(57) ABSTRACT

A strut structure for a crane comprising a strut arm extending longitudinally along a strut axis and comprising a foot and a top on which a hooking member for a sling is provided, and at least one tie rod including an upper tie rod end fastened to the top of the strut arm, at least one toggle leg mounted on the foot of the strut arm in front of the tie rod and having a lower end intended to form a toggle footing for the strut structure in a toggled position of the at least one toggle leg.

### FIELD

The present disclosure relates to a strut structure for a crane.

It relates more particularly to a strut structure comprising a strut arm and at least one tie rod fastened on one side to the strut arm and intended to be fastened on the other side to a counter-jib of the crane.

The present disclosure finds application in the field of cranes, and in particular to the element-assembled cranes.

### BACKGROUND

As is known, an element-assembled crane (or top-slewing crane) is composed of independent structural elements, also called frame elements, which are assembled to form a structure or frame, and in particular to form a mast, also called a pylon (made up of several mast elements), a foot on which the mast is mounted, as well as a rotating part which comprises a jib holder at the top of the mast, a jib (made up of several jib elements) hingedly mounted on the front of the jib holder, a counter-jib mounted on the rear of the jib holder, and a strut structure mounted on the counter-jib.

The state of the art can be illustrated by the teachings of document CN 110 745 711 B, which discloses a strut structure for a crane, comprising a strut arm extending longitudinally along a strut axis and including a foot and a top, and at least one tie rod including an upper tie rod end fastened to the top of the strut arm.

The strut structure is generally handled and carried by slinging, whether during assembly or disassembly of the crane, that is to say, by positioning slings on the strut structure, or by hooking these same slings to a hook of a lifting device, such as a movable crane.

However, during this handling operation, there is a risk that the strut arm toggle, and therefore that the strut structure toggle, which can damage the strut structure and/or destabilize the lifting device. Indeed, during handling, the strut arm (which is a long part extending along a strut axis) moves from a horizontally lying position to a vertically raised position, or vice versa, with its foot resting on the ground, which causes the center of gravity of the strut structure to shift from one side of the strut arm to the other, thus creating the risk of toggling and therefore overturning.

### SUMMARY

The present disclosure provides a strut structure designed to minimize, or even avoid, the risk of toggling of the strut structure during its handling by slinging, both during assembly phase and disassembly phase.

To this end, the present disclosure provides a strut structure for a crane, comprising a strut arm extending longitudinally along a strut axis and including a foot and a top on which is provided a hooking member for a sling; and at least one tie rod including an upper tie rod end fastened to the top of the strut arm.

This strut structure is notable in that it comprises at least one toggle leg mounted on the foot of the strut arm in front of the tie rod and having a lower end intended to form a toggle footing for the strut structure in a toggled position of the at least one toggle leg.

Thus, the at least one toggle leg allows displacing the contact point on the ground when the strut arm moves from a horizontally lying position to a vertically raised position, that is to say the contact point is initially located on the foot of the strut arm and then this contact point changes to be located on the lower end of the at least one toggle leg. Thus, thanks to this change in the contact point, it is possible to avoid a change in balance during the raising of the strut arm, and thus the at least one toggle leg prevents the strut structure from falling.

It should be noted that the at least one toggle leg is mounted in front of the tie rod, which means that it is at the rear (counter-jib side), on the opposite side of the front (jib side).

Advantageously, in the toggled position, the lower end of the at least one toggle leg is positioned below the foot of the strut arm when a theoretical balance axis is arranged vertically, this theoretical balance axis being an axis passing through the hooking member and through the center of gravity of the strut structure.

In this toggled position, the lower end of the at least one toggle leg is below the foot when the theoretical balance axis is vertical, so that, when the strut structure is raised, it is the foot that first rests on the ground and then the lower end of the at least one toggle leg that rests on the ground, in place of the foot, to prevent a toggling or a falling.

Advantageously, in the toggled position, the theoretical balance axis is positioned between the lower end of the at least one toggle leg and the strut axis when said theoretical balance axis is arranged vertically.

To prevent the strut structure from toggling and falling, it is advantageous for the lower end of the at least one toggle leg to be behind (on the counter-jib side) the theoretical balance axis passing through the center of gravity of the strut structure. In this way, the toggle leg rests behind this theoretical balance axis to improve balancing when lifting the strut structure and prevent it from toggling over, which would cause it to fall.

According to one feature, the at least one toggle leg is selectively displaceable between the toggled position and a rest position in which the at least one toggle leg is stowed (or retracted) compared to the toggled position.

In an advantageous embodiment, in the rest position, the lower end of the at least one toggle leg is positioned above the foot of the strut arm when the theoretical balance axis is arranged vertically.

Thus, the at least one toggle leg is displaceable between the toggled position (used during sling handling operations, whether during assembly or disassembly) and the rest position (used during and after the assembly on the counter-jib, so that the at least one toggle leg is not a hindrance).

According to one possibility, the at least one toggle leg is displaceable (or movable) in pivoting or in translation between the toggled position and the rest position.

According to another possibility, the at least one toggle leg is mounted on a support that is assembled on the foot of the strut arm by a mechanical connection.

According to another possibility, the strut structure comprises a locking mechanism mounted on the support to lock the at least one toggle leg in the toggled position and in the rest position.

Advantageously, the mechanical connection between the support and the foot of the strut arm is a detachable mechanical connection.

Thus, it is possible to disassemble the support, with the at least one toggle leg, which is advantageous when the strut structure is assembled with the other elements of the crane to form transportable packages.

In a particular embodiment, the detachable mechanical connection is a pin connection that comprises at least one connecting pin ensuring a junction between the support and the foot of the strut arm.

It should be noted that the pin connection consists of a detachable assembly comprising a connecting pin (also called a spindle or shaft) passing through two elements, such as for example a clevis and a tenon in order to create a clevis/tenon connection.

In a particular embodiment, the strut structure comprises at least one reinforcing bar including an upper bar end fastened to the strut arm, between the foot and the top.

This embodiment of the strut structure is suitable for high-rise cranes, with the use of at least one reinforcing bar (also called a counter-buckling bar) whose function is to prevent buckling of the strut arm, particularly under heavy load at the end of the jib.

In a particular embodiment, the strut arm includes two sections of the strut arm, which are a right section of the strut arm and a left section of the strut arm, and the at least one toggle leg comprises two toggle legs which are a right toggle leg attached to the right section of the strut arm and a left toggle leg attached to the left section of the strut arm.

The present disclosure also relates to a crane comprising a rotating part at a top of a mast, said rotating part comprising a jib holder, a jib hinged on the jib holder, a counter-jib mounted on the jib holder and a strut structure as described above, wherein the foot of the strut arm is assembled on the counter-jib by a first detachable mechanical connection, and the at least one tie rod is assembled on the counter-jib by a second detachable mechanical connection.

The present disclosure also concerns a method for handling by slinging a strut structure as described above, during which the at least one toggle leg is in its toggled position such that its lower end forms a toggle footing for the strut structure on a ground when the strut arm moves from a horizontally lying position to a vertically raised position, or vice versa.

### BRIEF DESCRIPTION OF THE DRAWINGS

Other features and advantages of the present disclosure will become apparent upon reading the detailed description below, of a non-limiting example of implementation, made with reference to the appended figures in which:

FIG. 1 is a schematic partial side view of a rotating part of a crane, in which the jib holder, the jib, the counter-jib and the strut structure are visible;

FIG. 2 is a schematic side view of the strut structure of FIG. 1 during a slinging manipulation, with a zoom on a toggle leg in a toggled position;

FIG. 3 is a schematic side view of the strut structure of FIG. 1 in position on the counter-jib, wherein the at least one toggle leg is in a rest position, and comprising a first zoom on a connecting element between a tie rod, a reinforcing bar and the counter-jib, and a second zoom on a detachable intermediate connection between an upper half-strut and a lower half-strut;

FIG. 4 is a schematic perspective and partial view of the strut structure of FIG. 2 in position on the counter-jib;

FIG. 5 is a schematic view of the strut structure of FIGS. 1 to 3 once disassembled into two sub-assemblies;

FIG. 6 is a schematic perspective view zoomed on the connecting element between the tie rod, the reinforcing bar and the counter-jib, and on the arrangement for adjusting the length of the reinforcing bar; and

FIG. 7 is a schematic side and partial view of the strut structure of FIGS. 1 to 3, comprising a zoom on the connecting element between the tie rod, the reinforcing bar and the counter-jib, and on the arrangement for adjusting the length of the reinforcing bar.

### DETAILED DESCRIPTION

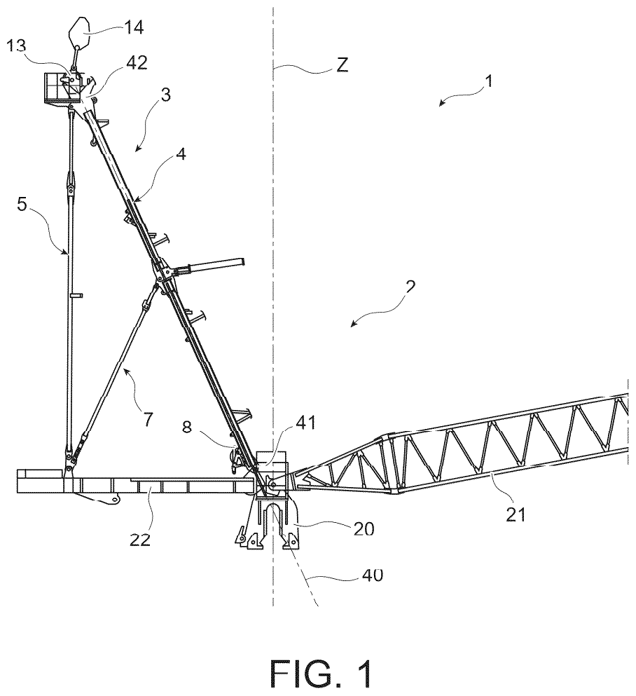

Referring to FIG. 1, a crane 1, here a luffing jib crane and element-assembled crane, comprises a base frame (not illustrated), static or movable on the ground, above which rises a mast (not illustrated) which extends along a vertical axis Z and which has a top on which is mounted, by means of a slewing device (not illustrated), a rotating part 2 orientable around the vertical axis Z.

This rotating part 2 comprises a jib holder 20 at the top of the mast, a jib 21 (made of several jib elements) hingedly mounted on the front of the jib holder 20, a counter-jib 22 mounted on the rear of the jib holder 20, and a strut structure 3 mounted on the counter-jib 22.

The jib 21 is movably mounted in rotation around a horizontal axis on the jib holder 20, so that the jib 21 can be raised and lowered.

The counter-jib 22 is fixedly mounted on the jib holder 20 in order to be rotationally secured thereto. The counter-jib 22 comprises a platform for carrying equipment which comprises, in particular, a raising winch 10 connected to the jib 21 for raising/lowering the jib 21 and a lifting winch 11 connected to a lifting hook (not illustrated) for lifting loads. The counter-jib 22 also carries counterweights 12.

More specifically, the raising winch 10 has a drum, around which is wound a raising cable which passes over a pulley 13 arranged at the top of the strut structure 3, and which also passes over the pulleys of a raising block 14 (illustrated in FIG. 1), located at the top 42 of the strut structure 3. The raising block 14 is connected, by a line of tie rods (not shown), to the jib 21.

The lifting winch 11 has a drum around which is wound a lifting cable, which passes through the strut structure 3, passes over at least one pulley (not illustrated) arranged on the jib 21, then is directed towards the tip of the jib 21 and extends to the lifting hook, with or without a reeving system; the loads to be lifted being suspended from the lifting hook when using the crane 1.

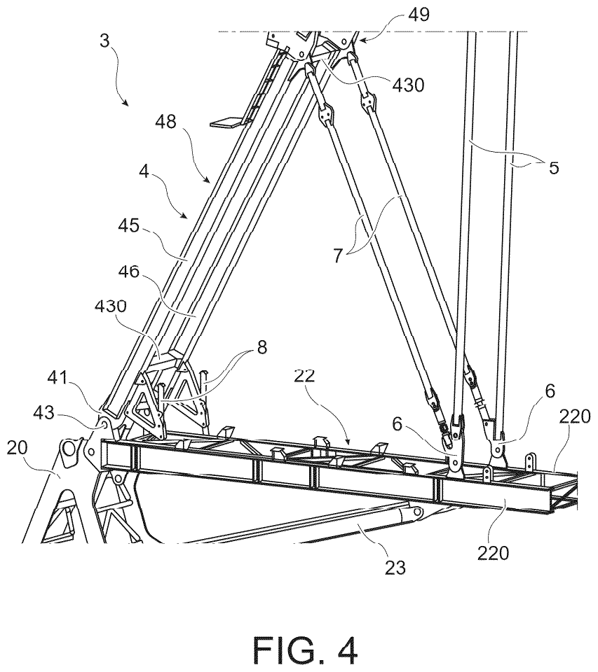

The counter-jib 22 can be mechanically coupled to the jib holder 20 by means of a reinforcing beam 23 (visible in FIG. 4) extending between the underside of the counter-jib 22 and the jib holder 20.

The strut structure 3 comprises a strut arm 4 extending longitudinally along a strut axis 40 and including a foot 41 and a top 42 (this top 42 forming the top of the strut structure 3). In position, this strut arm 4 extends obliquely upwards and backwards. The strut axis 40 is thus inclined backwards relative to the vertical axis Z at a strut angle comprised between 10 and 50 degrees.

The foot 41 of the strut arm 4 is assembled on the counter-jib 22 by a first detachable mechanical connection 43 which may be a pin connection; a pin connection consisting of a detachable assembly comprising a connecting pin (also called a spindle or shaft) passing through two elements, such as for example a clevis and a tenon in order to have a clevis/tenon connection.

The top 42 of the strut arm 4 is equipped with a hooking member 420 for hooking a sling, such as for example a hooking ring or slinging ring.

The strut structure 3 also comprises at least one tie rod 5 including an upper tie rod end 51 fastened on the top 42 of the strut arm 4 and a lower tie rod end 52 assembled on the counter-jib 22 by a second detachable mechanical connection 60 which may be a pin connection. Thus, in operation, the strut arm 4 is retained by the counter-jib 22 by means of the tie rod(s) 5.

The strut structure 3 comprises at least one reinforcing bar 7 including an upper bar end 71 fastened to the strut arm 4, between the foot 41 and the top 42, and a lower bar end 72 assembled on the counter-jib 22.

The strut structure 3 comprises at least one connecting element 6 for a mechanical connection between the at least one reinforcing bar 7 and the at least one tie rod 5. This at least one connecting element 6 is designed to be assembled on the counter-jib 22 by the second detachable mechanical connection 60 which, as a reminder, may be a pin connection.

The lower tie rod end 52 of the at least one tie rod 5 is assembled on the connecting element 6 by at least one detachable lower mechanical connection 53 which may be a pin connection comprising a lower connecting pin 530.

The lower bar end 72 of the at least one reinforcing bar 7 is fastened to the connecting element 6. The lower bar end 72 of the at least one reinforcing bar 7 may be securely fastened to the connecting element, for example by welding.

Thus, the at least one tie rod 5 and the at least one reinforcing bar 7 are assembled on the counter-jib 22 by the second detachable mechanical connection 60 of the at least one connecting element 6.

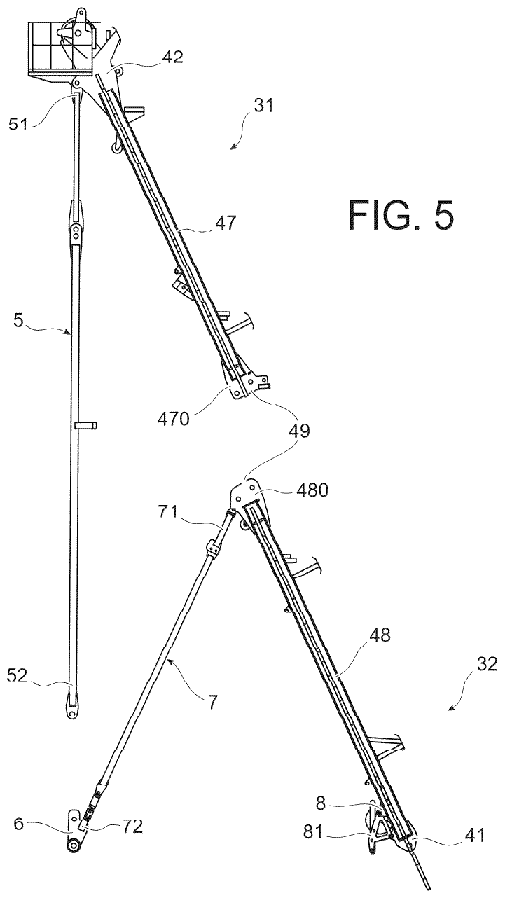

According to one possibility, the at least one reinforcing bar 7 includes a length adjustment arrangement 73 for adjusting the length of the at least one reinforcing bar 7, as visible in FIG. 4 and FIG. 5, which is for example positioned at the lower bar end 72.

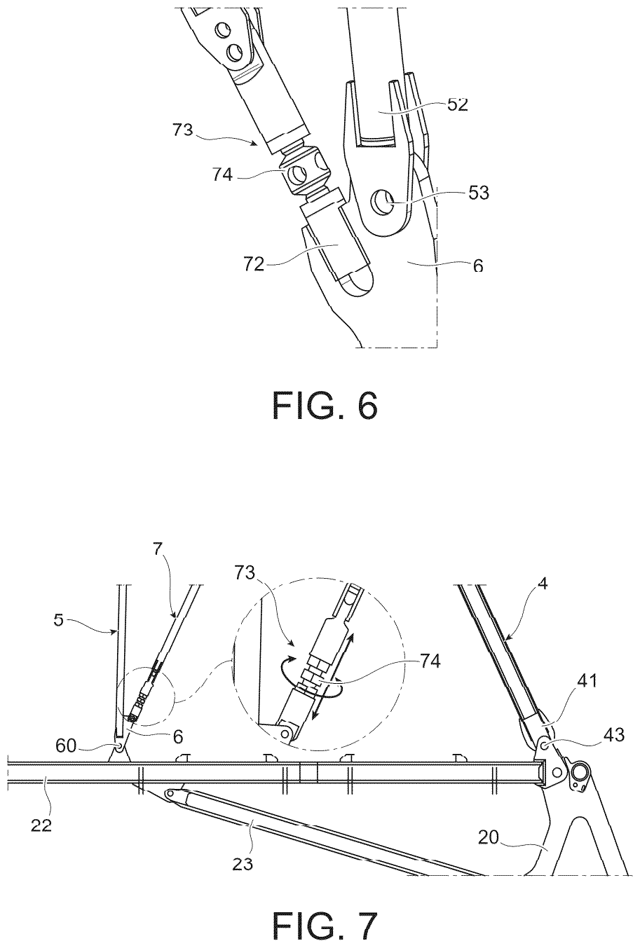

In the illustrated example visible in FIGS. 6 and 7, this length adjustment arrangement 73 comprises a screw tensioner equipped with a nut with reverse threads 74, such as for example a lantern nut.

Such a length adjustment arrangement 73 is advantageous because it makes it possible to avoid hyperstaticity in the assembly of the strut structure 3; the adjustment of the length of the reinforcing bar(s) 7 giving an advantageous degree of freedom to facilitate the mounting operations.

As visible in FIG. 4:
the strut arm 4 includes two sections 45, 46 of the strut arm, which are a right section 45 of the strut arm and a left section 46 of the strut arm which extend parallel along the strut axis 40 and which are joined by means of the foot 41, the top 42 and intermediate spacers 430;
the at least one tie rod 5 includes two tie rods 5, which are a right tie rod and a left tie rod that extend parallel to each other, wherein the right tie rod is fastened to the top 42 of the strut arm 4 on the side of the right section 45 of the strut arm, and the left tie rod is fastened to the top 42 of the strut arm 4 on the side of the left section 46 of the strut arm;
the at least one reinforcing bar 7 includes two reinforcing bars 7, which are a right reinforcing bar 7 and a left reinforcing bar 7 that extend parallel to each other, wherein the right reinforcing bar 7 is fastened to the right section 45 of the strut arm and the left reinforcing bar 7 is fastened to the left section 46 of the strut arm; and
the at least one connecting element 6 comprises two connecting elements 6 which are a right connecting element 6 and a left connecting element 6, arranged side by side on two separate beams 220 of the counter-jib 22, wherein the right connecting element 6 is assembled with the right tie rod 5 and the right reinforcing bar 7, and the left connecting element 6 is assembled with the left tie rod 5 and the left reinforcing bar 5.

Thus, the lower tie rod end 52 of the right tie rod 5 is assembled on the right connecting element 6 by a right detachable lower mechanical connection 53, and the lower tie rod end 52 of the left tie rod 5 is assembled on the left connecting element 6 by a left detachable lower mechanical connection 53. In other words, the at least one detachable lower mechanical connection 53 comprises a right detachable lower mechanical connection 53 and a left detachable lower mechanical connection 53 which respectively connect the right tie rod 5 to the right connecting element 6 and the left tie rod 5 to the left connecting element 6.

Furthermore, the lower bar end 72 of the right reinforcing bar 7 is fastened to the right connecting element 6, and the lower bar end 72 of the left reinforcing bar 7 is fastened to the left connecting element 6.

In the illustrated example, the right reinforcing bar 7 and the left reinforcing bar 7 each include the length adjustment arrangement 73.

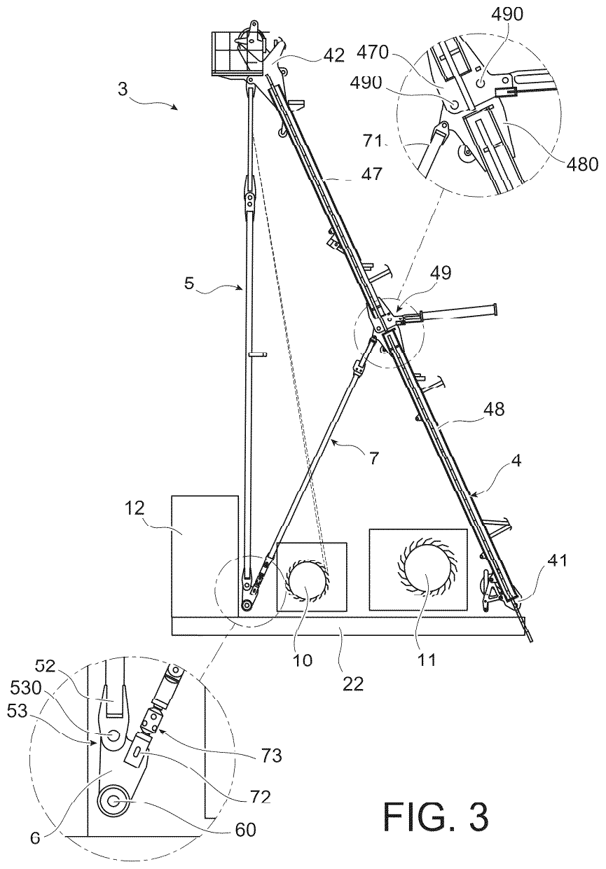

According to one feature and as visible in FIGS. 3 and 5, the strut arm 4 is divided into an upper strut half-arm 47 and a lower strut half-arm 48 assembled end to end by a detachable intermediate mechanical connection 49, the foot 41 forming part of the lower strut half-arm 48 and the top 42 forming part of the upper strut half-arm 47.

This detachable intermediate mechanical connection 49 may be a pin connection which comprises at least one intermediate connecting pin 490 providing a junction between the upper strut half-arm 47 and the lower strut half-arm 48. In the example illustrated, the detachable intermediate mechanical connection 49 comprises two intermediate connecting pins 490.

The upper strut half-arm 47 comprises a lower end 470 on the opposite side of the top 42, the lower strut half-arm 48 comprises an upper end 480 on the opposite side of the foot 41 and the at least one intermediate connecting pin 490 provides a junction between this lower end 470 and this upper end 480.

Furthermore, the upper bar end 71 of the at least one reinforcing bar 7 is fastened to the lower strut half-arm 48. According to one possibility, the upper bar end 71 of the at least one reinforcing bar 7 is fastened to the upper end 480 of the lower strut half-arm 48, as visible in FIG. 3.

As a reminder, in the example illustrated, the strut arm 4 includes two sections 45, 46 of the strut arm, which are a right section 45 of the strut arm and a left section 46 of the strut arm, such that:
the right section 46 of the strut arm is divided into an upper right half-section of the strut arm and a lower right half-section of the strut arm of the assembled end to end by the detachable intermediate mechanical connection 49;
the left section 46 of the strut arm is divided into an upper left half-section of the strut arm and a lower left half-section of the strut arm assembled end to end by the detachable intermediate mechanical connection 49;
the upper strut half-arm 47 comprises the upper right half-section of the strut arm and the upper left half-section of the strut arm secured to each other;
the lower strut half-arm 48 comprises the lower right half-section of the strut arm and the lower left half-section of the strut arm secured to each other.

Thus, the right tie rod 5 and the left tie rod 5 are fastened respectively to the upper right half-section of the strut arm and the upper left half-section of the strut arm, and the right reinforcing bar 7 and the left reinforcing bar 7 are fastened respectively to the lower right half-section of the strut arm and the lower left half-section of the strut arm.

Thus, and as visible in FIG. 5, the strut structure 3 is detachable into two sub-assemblies, after disassembly of the detachable intermediate mechanical connection 49 and of the at least one detachable lower mechanical connection 53, which are:
an upper sub-assembly 31 comprising the upper strut half-arm 47 and the at least one tie rod 5 (or the two tie rods 7 in the illustrated example); and
a lower sub-assembly 32 comprising the lower strut half-arm 48 and the at least one reinforcing bar 7 (or the two reinforcing bars 7 in the illustrated example) and the at least one connecting element 6 (or the two connecting elements 6 in the illustrated example) which remains attached to the at least one reinforcing bar 7.

Thus, the design of the strut structure 3 is based on a division into two sub-assemblies 31, 32 of generally triangular shape, such that the upper sub-assembly 31 can be disassembled from the lower sub-assembly 32 and from the counter-jib 22 in order to be carried separately, then the lower sub-assembly 32 can be disassembled from the counter-jib 22 in order to be carried separately in turn, before disassembling the counter-jib 22 which constitutes another element.

According to one possibility, the upper sub-assembly 31 has a first mass which is less than 10 tons, the lower sub-assembly 32 has a second mass which is less than 10 tons and the strut structure 3 has a total mass which corresponds to the sum of the first mass and the second mass and which is greater than 10 tons.

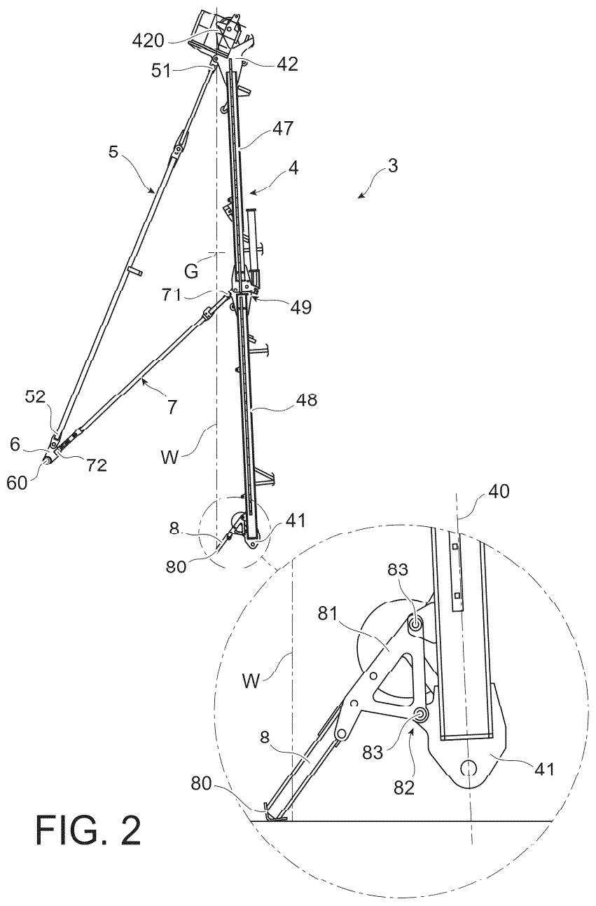

The strut structure 3 comprises at least one toggle leg 8 mounted on the foot 41 of the strut arm 4 in front of the tie rod 5 (therefore on the rear side or on the side of the counter-jib 22) and having a lower end 80 intended to form a toggle footing for the strut structure 3 because, in a toggled position (illustrated in FIG. 2), this at least one toggle leg 8 is deployed to have its lower end 80 below the foot 41 of the strut arm 4 when a theoretical balance axis W is disposed vertically (that is to say that the theoretical balance axis W extends parallel to the vertical axis Z); this theoretical balance axis W being an axis passing through the hooking member 420 and through the center of gravity G of the strut structure 3.

As visible in FIG. 2, in the toggled position of the toggle leg 8, the theoretical balance axis W is positioned between the lower end 80 of the at least one toggle leg 8 and the strut axis 40 when this theoretical balance axis W is disposed vertically; in other words, the lower end 80 of the at least one toggle leg 8 is behind (counter-jib side) the theoretical balance axis W, thus promoting the balancing of the strut structure 3 to prevent it from falling.

This at least one toggle leg 8 is movable or stowable into a rest position (illustrated in FIGS. 1, 3, 4 and 5), in which the at least one toggle leg 8 is stowed to have its lower end 80 above the foot 41 of the strut arm 4 when the theoretical balance axis W is disposed vertically.

Thus, this at least one toggle leg 8 is mounted movably on a support 81 between its toggled position and its rest position; this support 81 being assembled on the foot 41 of the strut arm 4 by a mechanical connection 82, and for example by a detachable mechanical connection such as a pin connection which comprises at least one connecting pin 83 providing a junction between the support 81 and the foot 41 of the strut arm 4.

Further provided is a locking mechanism mounted on the support 81 for locking the at least one toggle leg 8 in the toggled position and in the rest position. This locking mechanism may comprise a locking spindle which passes through the support 81 to block the toggle leg 8 in the toggled position and in the rest position.

As visible in FIG. 4, the at least one toggle leg 8 comprises two toggle legs 8 which are a right toggle leg 8 attached to the right section 45 of the strut arm and a left toggle leg 8 attached to the left section 46 of the strut arm.

In position on the crane 1, that is to say once the strut structure 3 is mounted and assembled on the counter-jib 22, the at least one toggle leg 8 is in its rest position. The at least one toggle leg 8 is even placed in its rest position during assembly on the counter-jib 22, so as not to interfere with or abut on the counter-jib 22, in particular during assembly of the foot 41 of the strut arm 4 on the counter-jib 22.

On the other hand, and as visible in FIG. 2, during the slinging manipulation operations of the strut structure 3, in particular on the ground when the strut structure 3 is lifted to straighten it or conversely when the strut structure 3 is lowered to lay it down, the at least one toggle leg 8 is in its toggled position, so that its lower end 80 forms a toggle footing for the strut structure 3 on the ground (see the zoom in FIG. 2) when the strut arm 4 passes from a horizontally lying position to a vertically raised position, or vice versa.

1. A strut structure for a crane, comprising:
a strut arm extending longitudinally along a strut axis and including a foot and a top on which is provided a hooking member for a sling; and
at least one tie rod including an upper tie rod end fastened to the top of the strut arm; and
wherein said strut structure comprises at least one toggle leg mounted on the foot of the strut arm in front of the tie rod and having a lower end intended to form a toggle footing for the strut structure in a toggled position of the at least one toggle leg.

2. The strut structure according to claim 1, wherein, in the toggled position, the lower end of the at least one toggle leg is positioned below the foot of the strut arm when a theoretical balance axis is arranged vertically, said theoretical balance axis being an axis passing through the hooking member and through the center of gravity of the strut structure.

3. The strut structure according to claim 2, wherein, in the toggled position, the theoretical balance axis is positioned between the lower end of the at least one toggle leg and the strut axis when said theoretical balance axis is arranged vertically.

4. The strut structure according to claim 3, wherein the at least one toggle leg is selectively movable between the toggled position and a rest position in which the at least one toggle leg is stowed compared to the toggled position.

5. The strut structure according to claim 4, wherein, in the rest position, the lower end of the at least one toggle leg is positioned above the foot of the strut arm when the theoretical balance axis is arranged vertically.

6. The strut structure according to claim 4, wherein the at least one toggle leg is movable in pivoting or in translation between the toggled position and the rest position.

7. The strut structure according to claim 1, wherein the at least one toggle leg is mounted on a support which is assembled on the foot of the strut arm by a mechanical connection.

8. The strut structure according to claim 7, comprising a locking mechanism mounted on the support for locking the at least one toggle leg in the toggled position and in the rest position.

9. The strut structure according to claim 7, wherein the mechanical connection between the support and the foot of the strut arm is a detachable mechanical connection.

10. The strut structure according to claim 9, wherein the detachable mechanical connection is a pin connection which comprises at least one connecting pin ensuring a junction between the support and the foot of the strut arm.

11. The strut structure according to claim 1, comprising at least one reinforcing bar including an upper bar end fastened to the strut arm, between the foot and the top.

12. The strut structure according to claim 1, wherein the strut arm includes two sections of the strut arm, which are a right section of the strut arm and a left section of the strut arm, and the at least one toggle leg comprises two toggle legs which are a right toggle leg attached to the right section of the strut arm and a left toggle leg attached to the left section of the strut arm.

13. A crane comprising a rotating part at a top of a mast, said rotating part comprising a jib holder, a jib hinged on the jib holder, a counter-jib mounted on the jib holder and a strut structure in accordance with claim 1, wherein the foot of the strut arm is assembled on the counter-jib by a first detachable mechanical connection, and the at least one tie rod is assembled on the counter-jib by a second detachable mechanical connection.

14. A method for handling by slinging a strut structure in accordance with claim 1, during which the at least one toggle leg is in its toggled position so that its lower end forms a toggle footing for the strut structure on a ground when the strut arm passes from a horizontally lying position to a vertically raised position, or vice versa.
